(19) United States
(12) Patent Application Publication
(10) Pub. No.: US 2026/0241344 A1
(43) Pub. Date: Aug. 20, 2026

(54) MODIFIED NANOCELLULOSE MEMBRANES AND THEIR USE IN FILTRATION

(71) Applicant: BOARD OF TRUSTEES OF THE UNIVERSITY OF ARKANSAS, Little Rock, AR (US)

(72) Inventors: Imen Bousrih, Fayetteville, AR (US); Jamie Hestekin, Fayetteville, AR (US)

(73) Assignee: BOARD OF TRUSTEES OF THE UNIVERSITY OF ARKANSAS, Little Rock, AR (US)

(21) Appl. No.: 19/543,102

(22) Filed: Feb. 18, 2026

Related U.S. Application Data
(60) Provisional application No. 63/760,085, filed on Feb. 18, 2025.

(51) Int. Cl. B01D 69/02; A23C 9/142; A23J 1/20; B01D 61/14; B01D 61/38; B01D 71/10

(52) U.S. Cl. CPC B01D 69/02; A23C 9/1422; A23J 1/20; B01D 61/145; B01D 61/38; B01D 71/10; B01D 2315/10; B01D 2325/18

(57) ABSTRACT

The invention relates to a filtration membrane that includes a surface. The surface is covalently coupled to a plurality of zwitterionic molecules that are operable to repel proteins and polypeptides from the membrane. The filtration membrane also includes a plurality of ionic liquids associated with the filtration membrane. The invention also relates to methods of filtering a material by associating the material with said filtration membranes, and methods of making such filtration membranes.

### CROSS-REFERENCE TO RELATED APPLICATIONS

This application claims priority to U.S. Provisional Patent Application No. 63/760,085, filed on Feb. 18, 2025. The entirety of the aforementioned application is incorporated herein by reference.

### BACKGROUND

A need exists for the development of membranes with improved resistance to protein fouling, longer operation lifetimes, and lower maintenance requirements. Numerous embodiments of the present disclosure aim to address the aforementioned need.

### SUMMARY

In some embodiments, the present disclosure pertains to a filtration membrane that includes a surface. In some embodiments, the surface is covalently coupled to a plurality of zwitterionic molecules. In some embodiments, the zwitterionic molecules are operable to repel proteins and polypeptides from the membrane. In some embodiments, the filtration membrane also includes a plurality of ionic liquids associated with the filtration membrane.

Additional embodiments of the present disclosure pertain to methods of filtering a material by associating the material with a filtration membrane of the present disclosure. Further embodiments of the present disclosure pertain to methods of modifying a filtration membrane by associating a surface of the filtration membrane with zwitterionic molecules. In some embodiments, the association results in the covalent coupling of the zwitterionic molecules with the surface of the filtration membrane.

### BRIEF DESCRIPTION OF THE DRAWINGS

A better understanding of the present invention can be obtained when the following detailed description is considered in conjunction with the following drawings, in which:

FIG. 1A provides an illustration of a filtration membrane in accordance with various embodiments of the present disclosure.

FIG. 1B provides chemical reactions for producing a modified nanocellulose (NC) ionic liquid membrane (ILM) modified with L-serine (NC-L-serine-ILM).

FIG. 2 provides a scheme for producing NC-L-serine-ILM and NC-ILM through a phase inversion process.

FIG. 3 provides an illustration of an ultrafiltration setup.

FIG. 4 provides a Fourier Transform Infrared Spectroscopy (FTIR) of carboxylate cellulose-L-serine and constituent materials.

FIGS. 5A-5B provide scanning electron microscopy (SEM) images of NC-ILM (FIG. 5A) and NC-L-serine-ILM (FIG. 5B).

FIG. 6 provides a permeance vs. time graph for NC-ILM and NC-L-serine-ILM at room temperature.

FIG. 7 provides a permeance vs. time graph for NC-ILM (non-modified membrane) at different temperatures.

FIG. 8 provides a permeance vs. time graph for NC-L-serine-ILM (modified membrane) at different temperatures.

FIGS. 9A-9B provide a permeance vs. time graph for non-modified (NC-ILM) and modified (NC-L-serine-ILM) membranes at 50° C. for different protein concentrations.

FIGS. 10A-10B provide a permeance vs. time graph for non-modified (NC-ILM) and modified (NC-L-serine-ILM) membranes at 5° C. for different protein concentrations.

FIGS. 11A-11C provide permeance vs. time graphs for non-modified (NC-ILM), modified (NC-L-serine-ILM) and commercial membranes room temperatures (FIG. 11A), 5° C. (FIG. 11B), and 50° C. (FIG. 11C).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components that include one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Ultrafiltration (UF) is a widely used separation technology across various industries, including dairy, biotechnology, and pharmaceuticals, where it plays a crucial role in protein concentration and the separation of biomolecules. However, membrane fouling, particularly from protein adsorption and aggregation, remains a major challenge in UF processes. Over time, proteins deposit on the membrane surface, leading to pore blockage, a reduction in permeate flux, and a decrease in operational efficiency. This fouling not only impacts productivity, but also increases operational costs due to the need for frequent cleaning cycles and membrane replacement.

Various strategies have been explored to minimize fouling, including the development of new membrane materials and surface coatings. However, traditional polymeric membranes, such as polysulfone (PS) and polyethersulfone (PES), still suffer from significant fouling, particularly during the filtration of protein-rich solutions. Despite advances in hydrophilic membrane development and chemical surface modifications aimed at reducing protein-membrane interactions, these approaches have only led to incremental improvements.

As such, a need exists for the development of novel membranes that offer improved resistance to protein fouling, longer operation lifetimes, and lower maintenance requirements. Numerous embodiments of the present disclosure aim to address the aforementioned need.

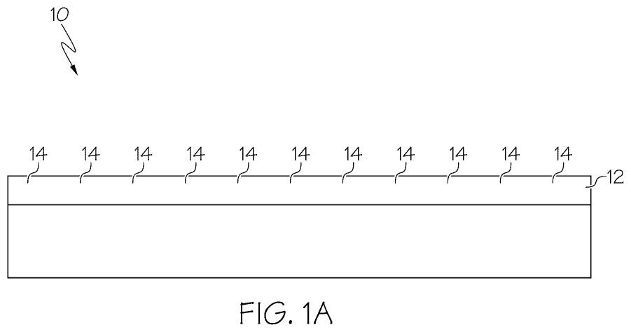

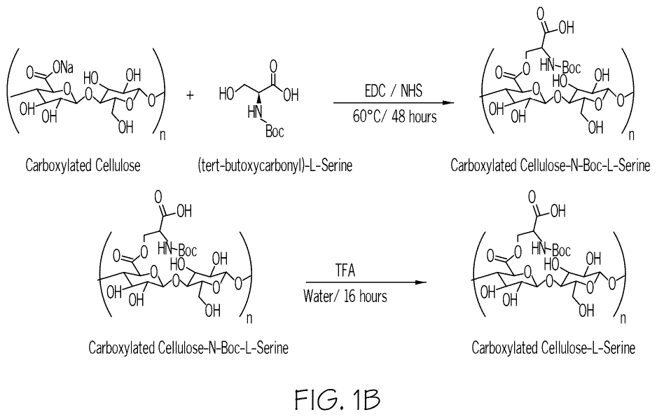

In some embodiments, the present disclosure pertains to a filtration membrane that includes a surface. In some embodiments, the surface is covalently coupled to a plurality of zwitterionic molecules. In some embodiments, the zwitterionic molecules are operable to repel proteins and polypeptides from the membrane. In some embodiments, the filtration membrane also includes a plurality of ionic liquids associated with the filtration membrane. An example of a filtration membrane of the present disclosure is illustrated in FIG. 1A as filtration membrane 10, which includes a surface 12 that is covalently coupled to a plurality of zwitterionic molecules 14.

Additional embodiments of the present disclosure pertain to methods of filtering a material by associating the material with a filtration membrane of the present disclosure. Further embodiments of the present disclosure pertain to methods of modifying a filtration membrane by associating a surface of the filtration membrane with zwitterionic molecules. As set forth in more detail herein, the disclosed filtration membranes, filtration methods, and methods of modifying filtration membranes can have numerous embodiments.

### Filtration Membranes

The filtration membranes of the present disclosure can be in various forms. For instance, in some embodiments, the filtration membranes of the present disclosure include, without limitation, a polymeric membrane, a cellulose membrane, a nanocellulose membrane, an ultrafiltration membrane, an ionic liquid membrane (ILM), or combinations thereof.

In some embodiments, the filtration membranes of the present disclosure include an ionic liquid membrane (ILM). In some embodiments, the filtration membranes of the present disclosure include a nanocellulose membrane. In some embodiments, the nanocellulose membrane includes an oxidized nanocellulose membrane. In some embodiments, the nanocellulose membrane includes a 2,2,6,6-tetramethylpiperidine-1-oxyl (TEMPO)-oxidized nanocellulose membrane.

The filtration membrane surfaces of the present disclosure can include various thicknesses. For instance, in some embodiments, the surface has a thickness of at least 500 nm.

### Ionic Liquids

In some embodiments, the filtration membranes of the present disclosure include a plurality of ionic liquids associated with the filtration membrane. Ionic liquids may be associated with filtration membranes in various manners. For instance, in some embodiments, the ionic liquids are embedded within pores of the filtration membrane.

The filtration membranes of the present disclosure may be associated with various types of ionic liquids. For instance, in some embodiments, the ionic liquids associated with the filtration membranes include, without limitation, imidazolium-based ionic liquids, ammonium-based ionic liquids, phosphonium-based ionic liquids, pyridinium-based ionic liquids, protic ionic liquids, or combinations thereof.

In some embodiments, ionic liquids associated with filtration membranes include imidazolium-based ionic liquids. In some embodiments, the imidazolium-based ionic liquids include, without limitation, 1-Ethyl-3-methylimidazolium acetate, 1-Butyl-3-methylimidazolium acetate, 1-Ethyl-3-methylimidazolium chloride, 1-Butyl-3-methylimidazolium chloride, 1-Ethyl-3-methylimidazolium tetrafluoroborate, or combinations thereof. In some embodiments, the imidazolium-based ionic liquids include 1-ethyl-3-methylimidazolium acetate.

In some embodiments, ionic liquids associated with filtration membranes include ammonium-based ionic liquids. In some embodiments, the imidazolium-based ionic liquids include, without limitation, tetraethylammonium acetate, tetramethylammonium chloride, choline acetate, choline chloride, or combinations thereof.

In some embodiments, ionic liquids associated with filtration membranes include phosphonium-based ionic liquids. In some embodiments, the phosphonium-based ionic liquids include, without limitation, trihexyl(tetradecyl)phosphonium chloride, trihexyl(tetradecyl)phosphonium bis(trifluoromethylsulfonyl)imide, or combinations thereof.

In some embodiments, ionic liquids associated with filtration membranes include pyridinium-based ionic liquids. In some embodiments, the pyridinium-based ionic liquids include, without limitation, 1-butylpyridinium chloride, 1-ethylpyridinium bromide, pyridinium-based ionic liquids, 1-butylpyridinium chloride, 1-ethylpyridinium bromide, or combinations thereof.

### Zwitterionic Molecules

The filtration membranes of the present disclosure may be associated with various zwitterionic molecules in various manners. For instance, in some embodiments, the zwitterionic molecules are in the form of a layer on a surface of the filtration membrane.

In some embodiments, the zwitterionic molecules include a negatively charged group and a positively charged group. In some embodiments, the negatively charged group includes a carboxylate group. In some embodiments, the positively charged group includes ammonium group.

In some embodiments, the zwitterionic molecules include, without limitation, L-Serine, L-Glycine, L-Alanine, L-Glutamic acid, L-Aspartic acid, sulfobetaine, phosphorylcholine, carboxybetaine, or combinations thereof. In some embodiments, the zwitterionic molecules include L-serine.

### Filtration Units

In some embodiments, the filtration membranes of the present disclosure may be a component of a filtration unit. In some embodiments, the filtration unit includes an inlet operable for receiving a material to be filtered, and an outlet operable for releasing the filtered material. In some embodiments, the filtration unit includes a cross-flow ultrafiltration unit.

### Properties

The filtration membranes of the present disclosure can have various advantageous properties. For instance, in some embodiments, the filtration membranes of the present disclosure exhibit a flux decline at room temperature of less than 10% after two hours of filtration. In some embodiments, the filtration membranes of the present disclosure exhibit a flux decline at room temperature of less than 5% after two hours of filtration. In some embodiments, the filtration membranes of the present disclosure exhibit a flux decline at room temperature of less than 2% after two hours of filtration.

### Methods of Filtering Materials

Additional embodiments of the present disclosure pertain to methods of filtering a material by associating the material with a filtration membrane of the present disclosure. As set forth in more detail herein, the filtration methods of the present disclosure can include numerous embodiments.

Various methods may be utilized to associate materials with the filtration membranes of the present disclosure. For instance, in some embodiments, the association includes contacting a material with a filtration membrane of the present disclosure. In some embodiments, the association includes associating a material with an inlet operable for receiving the material to be filtered. In some embodiments, the filtered material may then be released from an outlet.

The methods of the present disclosure may be utilized to filter various materials. For instance, in some embodiments, the filtered material includes, without limitation, a protein containing product, a dairy product, milk, non-dairy milk, soy milk, lactose-free milk, beverages, fruit juices, wines, biological samples, whole blood, plasma, or combinations thereof.

In some embodiments, the material to be filtered includes a protein containing product. In some of such embodiments, the filtered material includes enriched protein.

In some embodiments, the material to be filtered includes milk. In some of such embodiments, the filtered material includes milk protein concentrate.

### Methods of Modifying Filtration Membranes

Additional embodiments of the present disclosure pertain to methods of modifying a filtration membrane by associating a surface of the filtration membrane with zwitterionic molecules. In some embodiments, the association results in the covalent coupling of the zwitterionic molecules with the surface of the filtration membrane. In some embodiments, the association results in the formation of a layer of zwitterionic molecules on the surface of the filtration membrane.

In some embodiments, the filtration membrane includes a plurality of ionic liquids associated with the filtration membrane. In some embodiments, the methods of the present disclosure also includes a step of associating the ionic liquids with the filtration membrane.

### Applications and Advantages

The filtration membranes and methods of the present disclosure can provide numerous advantages. For instance, compared to conventional membranes, the filtration membranes of the present disclosure demonstrate significantly lower fouling rates, as evidenced by a more stable permeate flux over extended periods of operation. Additionally, the incorporation of zwitterionic molecules enhances the filtration membrane's hydrophilicity, further improving its antifouling properties. This advancement leads to increased operational efficiency, reduced cleaning frequency, and extended membrane lifespan, thereby addressing important challenges in industries such as dairy processing, biotechnology, and pharmaceuticals, where protein concentration and separation are key processes.

By reducing protein fouling and maintaining a higher permeate flux, the filtration membranes and methods of the present disclosure offer a significant improvement in membrane performance, contributing to cost savings and more sustainable filtration processes. In some embodiments, the filtration membranes and methods of the present disclosure set a new standard for ultrafiltration technology by combining enhanced fouling resistance with environmental and economic benefits.

As such, the filtration membranes and methods of the present disclosure can have numerous applications. For instance, in some embodiments, the filtration membranes and methods of the present disclosure can have dairy industry applications, such as applications in milk protein fractionation and concentration units, and lactose-free milk and protein filtration modules. In some embodiments, the filtration membranes and methods of the present disclosure can have food and beverage industry applications, such as applications in plant-based protein filtration and concentration units and juice and beverage clarification systems (e.g., filtration systems using the filtration membranes of the present disclosure to remove haze-causing proteins and other particulates from fruit juices, wines, and other beverages, leading to a clearer appealing product). In some embodiments, the filtration membranes and methods of the present disclosure can have healthcare and biomedical applications, such as applications in protein filtration in dialysis machines, lab-scale protein purification units, and blood plasma protein separation systems.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Enhanced Antifouling Performance of L-Serine-Modified Nanocellulose Membranes for Ultrafiltration in Dairy Processing

Fouling remains a significant challenge in ultrafiltration, particularly for protein-rich solutions. This Example presents a new modified nanocellulose (NC) ionic liquid membrane (ILM) modified with L-serine (NC-L-serine-ILM). NC-L-serine-ILM is designed to mitigate fouling through the grafting of L-serine as a zwitterion, thereby enhancing hydrophilicity and anti-fouling properties. The membrane's performance was evaluated under varying protein concentrations and temperatures, showing higher flux and reduced fouling compared to the unmodified membrane (NC-ILM). The modified membrane exhibited 30-58% flux reduction, significantly lower than the 61-85% observed for the NC-ILM at 50° C. Similar trends were noted at lower temperatures and at different protein concentrations. These results demonstrate the potential of NC-L-serine-ILM to improve ultrafiltration efficiency, offering a scalable solution for protein filtration and other industrial applications.

### Example 1.1. Introduction

Ultrafiltration is a common process used in the dairy industry to standardize the protein content of skim milk, either for consumption or before cheese production. However, one of the main challenges limiting the performance of ultrafiltration processes is membrane fouling. This fouling occurs due to non-specific interactions between proteins and the membrane surface, which reduces productivity and necessitates frequent cleaning operations—typically twice daily, with 2-3 hours of cleaning for every 6-8 hours of production to restore an acceptable flux.

To address protein fouling, a variety of strategies have been developed. These include chemical modifications to the membrane surface, such as introducing hydrophilic polymers like polyvinylpyrrolidone (PVP) or polyethylene glycol (PEG). Recent research has also focused on developing zwitterionic surfaces, inspired by the zwitterionic nature of phospholipid cell membranes. These surfaces exhibit low fouling behavior due to their ability to form strong hydration layers of water molecules through electrostatic and hydrogen bonding interactions, which effectively exclude proteins from adhering to the surface.

The primary focus in zwitterionic materials research has been on compounds like sulfobetaine, phosphorylcholine, and carboxybetaine. Amino acids have been less explored, despite their promising anti-fouling capabilities. Notably, serine, an uncharged polar amino acid, has shown strong interactions with water molecules, enabling the formation of a robust hydration layer. Given its properties, serine holds significant potential as an effective zwitterionic material for creating membranes with enhanced fouling resistance.

High temperatures in the range of 40-55° C. have traditionally been used in many membrane separation processes for milk, as this is considered the optimal range for reducing fouling and increasing separation efficiency. However, such high temperatures can also promote unwanted microbial growth in the resulting retentates. In recent years, low-temperature ultrafiltration (UF), typically below 15° C., has gained popularity in the dairy industry. Filtration at low temperatures, often between 5-10° C., has the advantage of controlling microbial growth during filtration, thereby limiting the microbial load in the resulting retentates. As dairy manufacturers shift toward low-temperature membrane operations, there is a growing need for improved membrane configurations that can achieve high separation and anti-fouling efficiency while maintaining sustainable performance under these cooler conditions. In the United States, the legal temperature used on farmer dairy processing is less than 7° C.

In this Example, Applicant evaluated the effectiveness of L-serine-modified nanocellulose membrane in mitigating fouling. Applicant also investigated the influence of processing temperature on flux decline behavior during skim milk ultrafiltration (UF). By addressing the dual challenges of fouling and performance variability at both high and low operating temperatures, this work aims to demonstrate the potential of these modified membranes to enhance UF efficiency and durability in protein-rich dairy processing environments.

### Example 1.2. Materials

A commercial skim milk that contained 33 g/L of proteins and Og/L fat was utilized. The composition reported by the manufacturer is shown in Table 1.

TABLE 1
Skim milk composition.

| Skim milk | Concentration (g/L) |
|---|---|
| Protein | 33 |
| Fat | 0 |
| Carbohydrates (Sugar) | 45.8 |
| Calcium | 9.9 |
| Sodium | 0.5 |
| Cholesterol | 0.02 |

N-(tert-Butoxycarbonyl)-L-serine, trifluoroacetic acid, N-(3-Dimethylaminopropyl)-N′-ethylcarbodiimide hydrochloride, NHS, dimethylformamide and 1-Ethyl-3-methylimidazolium acetate were purchased from Sigma Aldrich (St. Louis, MO). All the chemicals and solvents were used without further purification. The membrane support polyester (CU 434) was purchased from CESSNER (New Hyde Park, NY). A porometer memcast was used for casting the membranes.

### Example 1.3. Synthesis of the Modified Nanocellulose

The carboxylate nanocellulose (or TEMPO oxidized cellulose) was prepared as previously reported. Polymers (Basel). 2020 Jun. 15; 12(6):1348. The modified nanocellulose (nanocellulose-L-serine) was prepared as presented in FIG. 1B. The carboxylate cellulose was dissolved in DMF with the (tert-butoxycarbonyl) L-serine in the presence of EDC and NHS as a coupling agent to facilitate the formation of covalent bonds between the carboxyl group (—COOH) on the surface of nanocellulose and the hydroxyl group (—OH) of L-serine. The reaction was carried out at 60° C. for 48 hours. The Boc protection group was removed from L-serine residues to expose the amino group. This deprotection is typically achieved using the TFA. Finally, after 16 hours, water was added to stop the deprotection step and obtain the cellulose-L-serine powder.

### Example 1.4. Membrane

Two different membranes were used in this Example. One made from nanocellulose and the other from nanocellulose modified with L-serine. Initially, carboxylate cellulose and carboxylate cellulose-L-serine were dissolved in an ionic liquid as a solvent. The NC-ILM (nanocellulose ionic liquid membrane) and NC-L-serine-ILM (nanocellulose-L-serine ionic liquid membrane) were made via phase inversion methods at room temperature with a coating thickness of 500 nm by a porometer memcast.

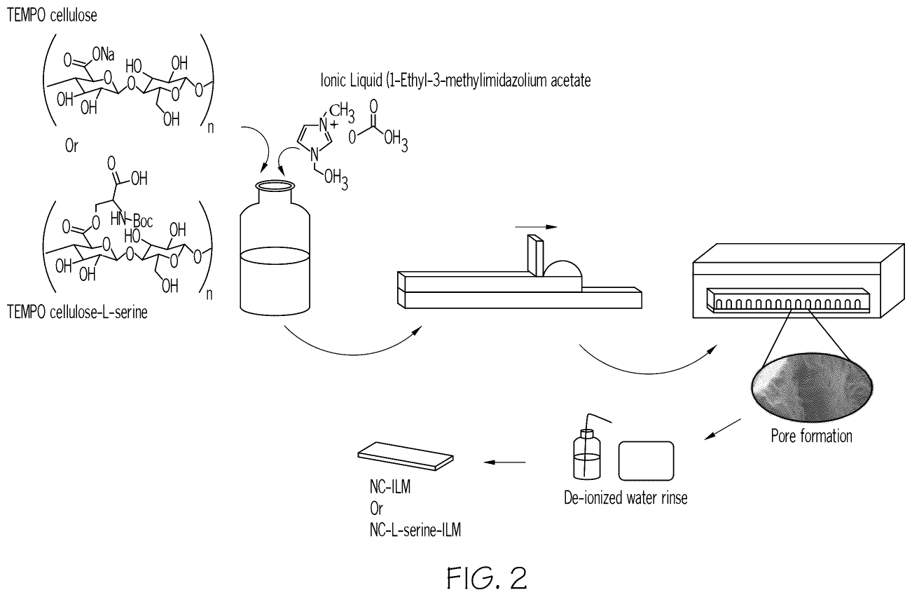

This process is presented in FIG. 2. Specifically, the process started by dissolving Applicant's modified nanocellulose in ionic liquid (1-Ethyl-3-methylimidazolium acetate). The dissolving solution was then applied to a support layer. A blade was used to cover all the surface of the support layer with the modified nanocellulose, which developed a thickness of 500 nm. After applying the solution, the coated membrane was immersed in a nanosolvent bath (water bath) that does not dissolve the polymer but does dissolve the solvent used in the polymer solution, which is the ionic liquid. The ionic liquid began to exchange with water, causing the polymer to solidify and form a porous membrane structure.

### Example 1.5. Cross-Flow System and Ultrafiltration Process

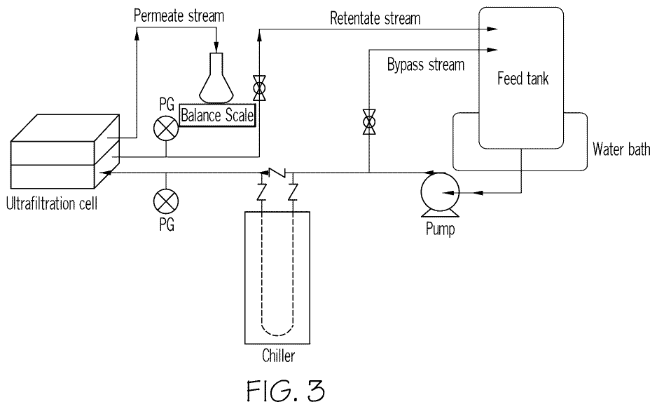

Ultrafiltration experiments were carried out on a custom-built ultrafiltration rig (FIG. 3). The ultrafiltration cell consisted of feed and permeate plates that were inserted between the membrane. A feed spacer and permeate carrier were inserted along the feed and permeate channels, respectively. The ultrafiltration surface dimensions were 0.14 m×0.1 m, providing an ultrafiltration area of 0.014 m². The assembled cell plates were secured with stainless screws.

A gear pump was used to deliver the feed solution to the filtration cell. At low temperatures (5° C.), the feed would be passed through a set of cooling coil immersed in a water bath and the water bath temperature would be controlled by a thermoregulator connected to a chiller. Applicant immersed the feed tank in a hot water bath for high temperatures (50° C.). Filtration was performed under constant pressure, with the desired flow rate and pressure controlled. Permeate was collected in a beaker placed on a mass balance to measure its mass at regular time intervals. Two pressure gauges were connected in the inlet and outlet of the filtration cell to monitor the feed and retentate streams, respectively. Fresh membranes were used for each run, and all the experiments were done for 6 hour periods, with flow rate measurements taken at regular intervals to see the fouling of those membranes and how the modifications can affect their performance during the time.

The efficiency of membrane performance during protein concentration is crucial in dairy processing. As protein concentration and viscosity increases from one step to the next, membrane performance is affected by increasing fouling, which reduces productivity over time. In this Example, different concentrations levels (1-3×) were tested to evaluate the membrane's capacity to resist fouling.

### Example 1.6. Sample Analysis

Permeate samples from the ultrafiltration experiments were collected at selected time intervals for protein analysis. The total protein concentrations in both the feed and permeate streams were determined using a combustion analyzer, with a nitrogen-to-protein conversion factor of 6.38. Protein rejection is calculated using the relative protein concentration in the feed and permeate in Equation 1.

$$Rejection = ( 1 - \frac{{C}_{permeate}}{{C}_{feed}} ) \times 100 \% \qquad Eq . 1$$

### Example 1.7. FTIR and XPS Analyses

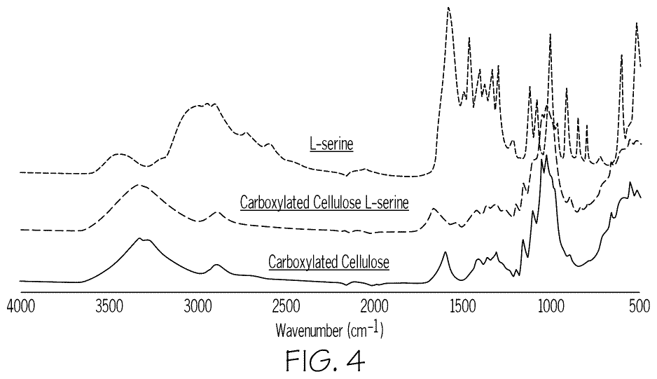

To evaluate the success of the modification reaction (FIG. 1B) and the attachment of L-serine with the carboxylate cellulose, Fourier Transform Infrared Spectroscopy (FTIR) analysis was performed on dry powders of each coating material using PerkinElmer (Waltham, MA) Fronter FTIR. As shown in FIG. 4, the FTIR spectrum of carboxylate cellulose-L-serine clearly displays a combination of the principal peaks from both L-serine and carboxylate cellulose. Specifically, the appearance of the N—H bending peak (~1600 cm⁻¹) characteristic of L-serine, along with the C═O stretching band (~1730 cm⁻¹) from the carboxylate groups of cellulose, confirms the successful grafting of L-serine onto the cellulose backbone. Additionally, the broadening of the O—H stretching band (~3400 cm⁻¹) suggests enhanced hydrogen bonding and new interactions between the L-serine and cellulose components, further supporting the successful modification. These spectral features indicate the formation of a stable hybrid material, where L-serine is effectively bound to the carboxylate cellulose structure.

To assess the removal of sodium in the carboxylate cellulose and quantify the increase in specific elements due to the attachment of L-serine to the CC, X-ray photoelectron spectroscopy (XPS) measurements were performed on both materials (Caboxylate cellulose and carboxylate cellulose-L-serine). The analyses were carried out using a VersaProbe instrument from Physical Electronic (Chanhassen, MN). Carbon, oxygen, nitrogen and sodium were measured.

The XPS analysis for carboxylate cellulose revealed the presence of sodium (3.7%) and an absence of nitrogen (0%), as expected. In contrast, carboxylate cellulose-L-serine showed 4.1% nitrogen and no detectable sodium, confirming the successful attachment of L-serine to the carboxylate cellulose.

### Example 1.8. SEM Results

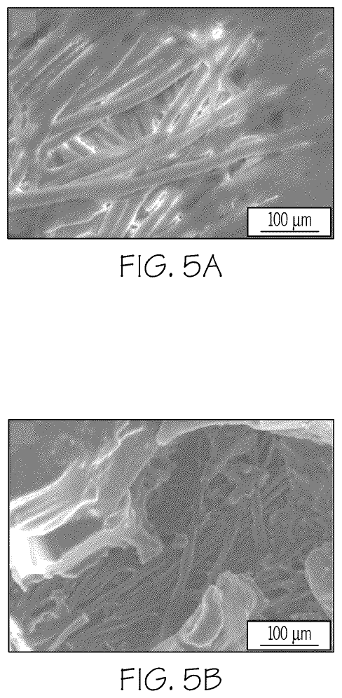

In the SEM images shown in FIGS. 5A-5B, Applicant can observe a fiber with a clear structural difference between the NC-ILM (FIG. 5A) and the modified nanocellulose membrane NC-L-serine-ILM (FIG. 5B). In the NC-ILM, the fiber appears intertwined but with significant spacing between them, suggesting a highly porous structure that would allow fluid flow through the membrane. This configuration may be more susceptible to fouling as it allows proteins and other particles to penetrate and deposit on the surface. After modification with L-serine, the nanocellulose structure appears denser and more compact. The fibers show reduced spacing, which indicate that L-serine grafting has added additional material between fibers, potentially reducing pore size and increasing hydrophilicity.

### Example 1.9. Ultrafiltration at Room Temperature

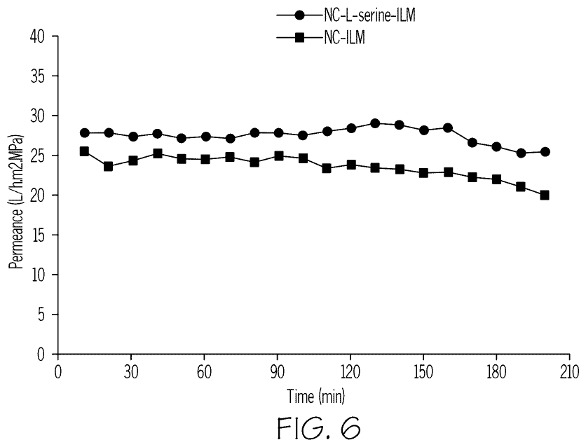

An initial 3-hour ultrafiltration experiment was performed at room temperature under a constant pressure of 0.3 MPa to assess the impact of membrane modification on fouling resistance, comparing both the non-modified membrane (NC-ILM) and the modified membrane (NC-L-serine-ILM). As shown in FIG. 6, the permeance for both membranes shows a gradual decline over time, indicating typical fouling behavior. However, the rate of decline was significantly different between the two membranes: the flux for the NC-ILM dropped by 22%, while the NC-L-serine-ILM experienced a much smaller decrease of only 8%.

These results suggest that the presence of zwitterion molecules on the membrane surface reduces fouling. Additionally, Applicant's modified membrane showed an enhanced flow rate and lower fouling compared to the NC-ILM membranes without the L-serine. Such results indicate that Applicant's approach to zwitterionic modification is particularly effective in maintaining high flux over extended operational periods.

### Example 1.10. Influence of Processing Temperature on Modified Membrane Performance

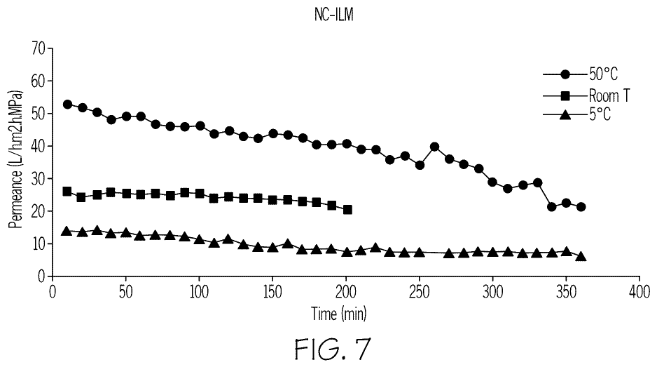

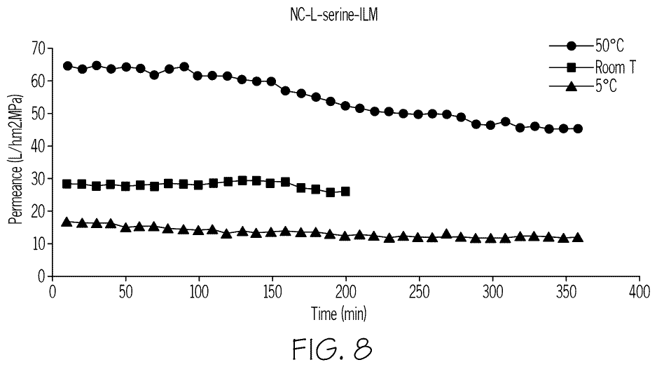

During the ultrafiltration, permeate flux was measured at regular intervals for both membranes. Initially, the flux remained consistent during the first few hours, especially for the modified membrane, but gradually declined over time at each processing temperature, as shown in FIGS. 7-8 for the non-modified (NC-ILM) and modified (NC-L-serine-ILM) membranes, respectively. The initial permeance for the non-modified membrane was 13.44, 25.57 and 52.79 L/h·m²·MPa for feed temperatures of 5° C., room temperature (approximately 23° C.) and 50° C., respectively. For the modified membrane, the initial permeance was 16.57, 27.89 and 63.83 L/h·m²·MPa for the same temperatures. From 5 to 50° C., the permeance increased by ~392% for the NC-ILM and ~385% for the NC-L-serine-ILM. Without being bound by theory, this is likely caused by reduced permeate viscosities at higher temperatures.

At all tested temperatures, the reduction in permeance for the modified nanocellulose membrane was 8% at room temperature, 30% at 50° C. and 30% at 5° C. This demonstrates significantly less fouling compared to the non-modified membrane, which exhibited reductions of 22%, 61% and 57% at the same respective temperatures. These results indicate that the modified membrane exhibits a significantly low fouling compared to the non-modified membrane at different temperatures.

The decline in flux (or permeance) observed in this Example for both membranes can be attributed to various factors related to skim milk components, such as minerals, protein and casein micelles, which influence fouling mechanisms during UF. Particle deposition on the membrane surface and pore blockage contributes to fouling, resulting in a gradual reduction in flux over time. The mechanism of fouling consists of blocking pore or even surface deposition, which can occur through protein adsorption, mineral precipitation or aggregation of protein on the surface of the membrane. Protein adsorption may have contributed to the fouling observed during ultrafiltration at 5° C., room temperature and 50° C., for the NC-ILM. In contrast, the modified membrane (NC-L-serine-ILM), exhibited significantly less fouling. This reduction in fouling is attributed to the presence of a strong hydration layer formed by the zwitterionic molecule on the membrane surface, which effectively prevents proteins deposition by repelling proteins and maintaining a hydrated barrier.

For the unmodified membrane, the flux decline was both more pronounced and more rapid at 50° C. compared to 5° C. and room temperature. This behavior can be related to temperature inducing conformational changes in β-lactoglobulin (β-LG). These changes occur between 4° and 55° C. at approximately neutral pH. During this transition, β-LG transfer from a dimer to a monomer, increasing its hydrophobicity and exposing embedded thiol groups that participate in thiol disulfide interactions, which can lead to accumulation. This protein accumulation promotes early fouling and contributes to the rapid flux decline observed at 50° C.

For the modified membrane, the flux reduction was significantly less, approximately half that of that observed with the unmodified membrane. This improvement can be explained by the repulsion of proteins facilitated by the hydration layer formed by the zwitterionic (L-serine) molecules, which effectively prevents proteins accumulation on the membrane surface, thereby reducing fouling.

### Example 1.11. Influence of Processing Concentration on Modified Membrane Performance

The performance of both membranes, NC-ILM (non-modified) and NC-L-serine-ILM (modified), was evaluated for concentrating dairy solutions for low and high temperature with varying protein content in the feed, using the same experimental setup. Those concentration experiments were performed in batch mode, with simultaneous recycling of the retentate and continuous removal of the permeate.

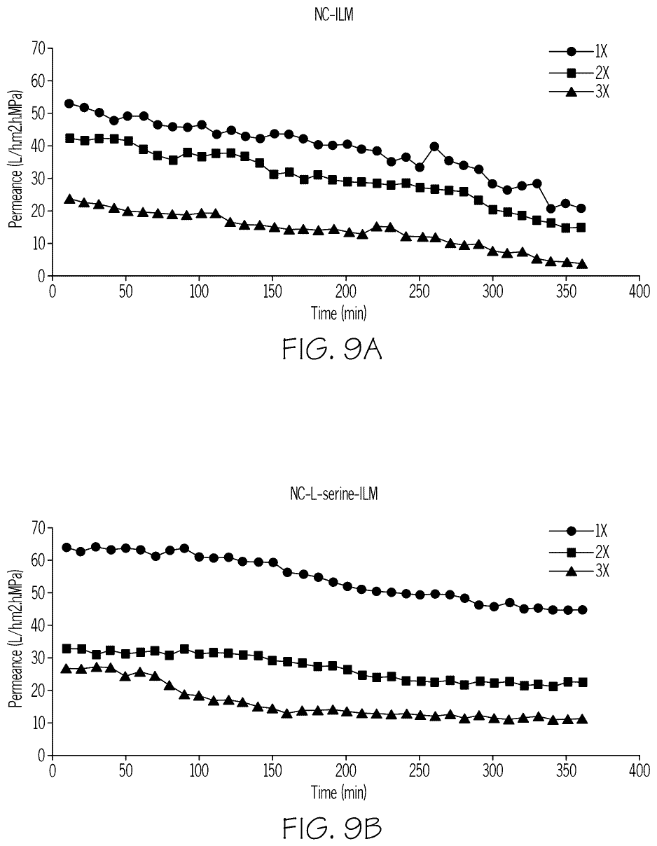

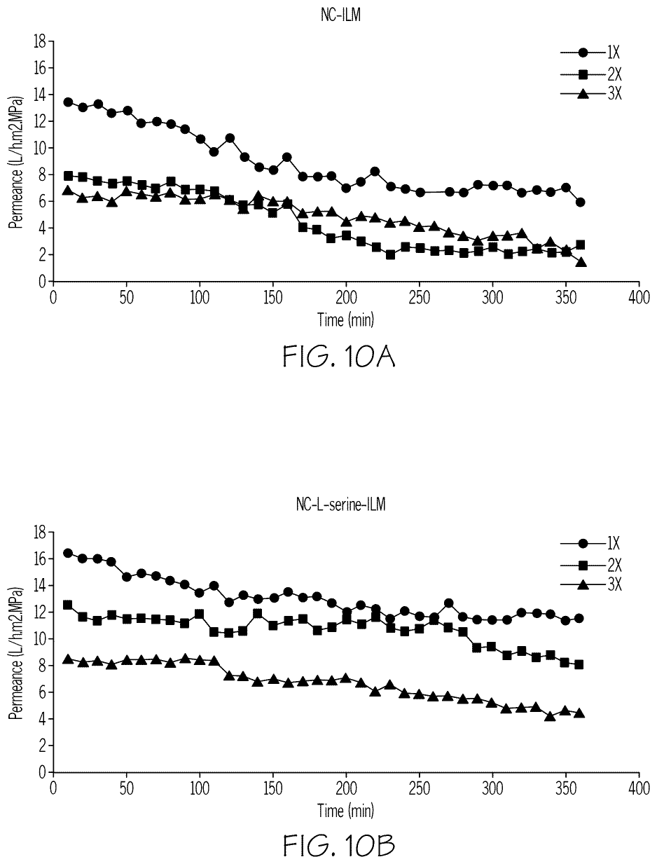

As shown in FIGS. 9A-9B and 10A-10B, across all temperature conditions, the modified membrane consistently exhibited higher flux and significantly reduced fouling compared to the non-modified membrane, even with increasing protein concentration. At 50° C., the flux values for the modified membrane at protein concentrations of 1, 2 and 3× were 63.83, 32.68 and 26.95 L/h·m²·MPa, respectively, compared to 52.79, 42.20 and 23.64 L/h·m²·MPa for the non-modified membrane. The corresponding flux reductions for the NC-L-serine-ILM were 30%, 33% and 60%, which were significantly lower than the 61%, 65% and 85% reduction observed for the NC-ILM at the same protein concentration. These results also show an improvement over conventional polysulfone membranes, which typically exhibit higher fouling rates under similar conditions.

This performance of the modified membrane was shown also at lower temperature conditions, where the fouling of the modified membrane was less than the non-modified membrane at different protein concentrations, where it reduced by 30%, 36% and 48% for the NC-L-serine-ILM and 57%, 65% and 79% for the NC-ILM. At lower temperatures, this trend continued, with the modified membrane demonstrating far less fouling than the non-modified membrane. For the NC-L-serine-ILM, flux reductions at protein concentrations of 1×, 2×, and 3× were 30%, 36%, and 48%, respectively. In contrast, the NC-ILM membrane showed much more severe fouling, with flux reductions of 57%, 65%, and 79% at the same protein concentrations.

The improved performance of the NC-L-serine-ILM membrane can be attributed to its enhanced antifouling properties, likely due to the formation of a hydration layer on the membrane surface, which reduces protein adsorption and pore blockage. This performance advantage is particularly notable at both high and low temperatures, where the non-modified membrane suffered greater fouling due to protein deposition and pore clogging, especially at higher protein concentrations. The NC-L-serine-ILM membrane's ability to maintain higher flux and resist fouling across a range of operating conditions makes it a promising candidate for dairy ultrafiltration applications, where consistent performance and reduced maintenance costs are critical.

### Example 1.12. Modified Membranes have Enhanced Performance Over Existing Membranes

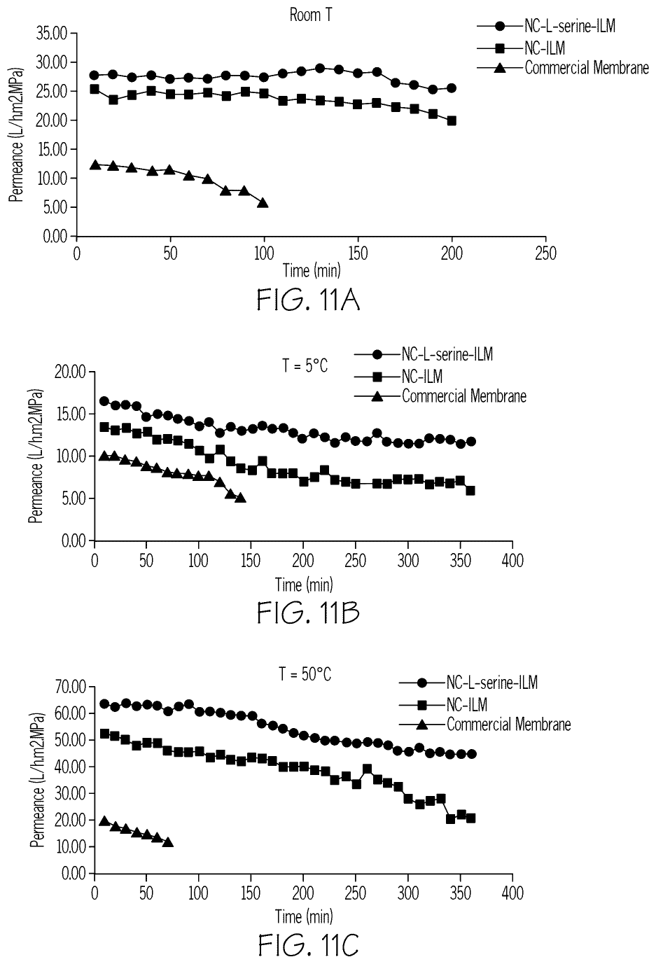

Applicant compared the performance of non-modified (NC-ILM) and modified (NC-L-serine-ILM) membranes to commercial membranes (as described in Foods, (2020) 9(11), 1721, doi: 10.3390/foods9111721). FIGS. 11A-11C provide permeance vs. time graphs for non-modified (NC-ILM), modified (NC-L-serine-ILM) and commercial membranes at room temperatures (FIG. 11A), 5° C. (FIG. 11B), and 50° C. (FIG. 11C). The modified membranes demonstrated superior flux reductions of only 1%, 23%, and 1% after 2 hours of filtration at room temperature (FIG. 11A), 5° C. (FIG. 11B), and 50° C. (FIG. 11C), respectively. The non-modified membranes demonstrated flux reductions of 8%, 20%, and 7% after 2 hours of filtration at room temperature (FIG. 11A), 5° C. (FIG. 11B), and 50° C. (FIG. 11C), respectively. Commercial membranes demonstrated flux reductions of 52%, 50%, and 38% after 2 hours of filtration at room temperature (FIG. 11A), 5° C. (FIG. 11B), and 50° C. (FIG. 11C), respectively. Such results affirm that the modified membranes (NC-L-serine-ILM) have superior performance over non-modified (NC-ILM) and commercial membranes.

### Example 1.13. Summary

The results of this Example demonstrate that the L-serine-modified nanocellulose membrane exhibited superior antifouling performance and higher flux compared to the unmodified membrane in protein-rich dairy ultrafiltration. The zwitterionic L-serine grafting enhanced hydrophilicity and minimized protein fouling by forming a hydration layer on the membrane surface. Across various temperatures (5° C., room temperature, and 50° C.) and protein concentrations, the NC-L-serine-ILM consistently exhibited lower flux reductions and outperformed the NC-ILM. At 50° C., where protein fouling is most severe, the modified membrane reduced fouling by nearly half compared to the unmodified membrane. This efficiency was maintained even under high protein loads and low-temperature conditions.

The NC-L-serine-ILM shows significant potential for industrial dairy ultrafiltration, improving productivity, reducing maintenance requirements, and extending membrane lifespan. Moreover, its scalable design makes it a promising solution for protein filtration applications.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein

1. A filtration membrane comprising a surface, wherein the surface is covalently coupled to a plurality of zwitterionic molecules, wherein the zwitterionic molecules are operable to repel proteins and polypeptides from the membrane, and wherein the filtration membrane comprises a plurality of ionic liquids associated with the filtration membrane.

2. The filtration membrane of claim 1, wherein the filtration membrane is selected from the group consisting of a polymeric membrane, a cellulose membrane, a nanocellulose membrane, an ultrafiltration membrane, an ionic liquid membrane (LM), or combinations thereof.

3. The filtration membrane of claim 1, wherein the filtration membrane comprises a nanocellulose membrane.

4. The filtration membrane of claim 1, wherein the filtration membrane comprises an ionic liquid membrane (LM).

5. The filtration membrane of claim 1, wherein the ionic liquids associated with the filtration membrane comprise imidazolium-based ionic liquids, wherein the imidazolium-based ionic liquids are selected from the group consisting of 1-Ethyl-3-methylimidazolium acetate, 1-Butyl-3-methylimidazolium acetate, 1-Ethyl-3-methylimidazolium chloride, 1-Butyl-3-methylimidazolium chloride, 1-Ethyl-3-methylimidazolium tetrafluoroborate, or combinations thereof.

6. The filtration membrane of claim 5, wherein the imidazolium-based ionic liquids comprise 1-ethyl-3-methylimidazolium acetate.

7. The filtration membrane of claim 1, wherein the zwitterionic molecules comprise a negatively charged group and a positively charged group, wherein the negatively charged group comprises a carboxylate group, and wherein the positively charged group comprises ammonium group.

8. The filtration membrane of claim 1, wherein the zwitterionic molecules are selected from the group consisting of L-Serine, L-Glycine, L-Alanine, L-Glutamic acid, L-Aspartic acid, sulfobetaine, phosphorylcholine, carboxybetaine, or combinations thereof.

9. The filtration membrane of claim 1, wherein the zwitterionic molecules comprise L-serine.

10. The filtration membrane of claim 1, wherein the filtration membrane exhibits a flux decline at room temperature of less than 5% after two hours of filtration.

11. The filtration membrane of claim 1, wherein the filtration membrane is a component of a filtration unit, wherein the filtration unit further comprises an inlet operable for receiving a material to be filtered, and an outlet operable for releasing the filtered material.

12. A method of filtering a material, said method comprising:
associating the material with a filtration membrane, wherein the filtration membrane comprises a surface, wherein the surface is covalently coupled to a plurality of zwitterionic molecules, wherein the zwitterionic molecules are operable to repel proteins and polypeptides from the membrane, and wherein the filtration membrane comprises a plurality of ionic liquids associated with the filtration membrane.

13. The method of claim 12, wherein the associating comprises associating the material with an inlet operable for receiving the material to be filtered, and wherein the filtered material is released from an outlet.

14. The method of claim 12, wherein the material is selected from the group consisting of a protein containing product, a dairy product, milk, non-dairy milk, soy milk, lactose-free milk, beverages, fruit juices, wines, biological samples, whole blood, plasma, or combinations thereof.

15. The method of claim 14, wherein the material comprises a protein containing product, and wherein the filtered material comprises enriched protein.

16. The method of claim 12, wherein the material comprises milk, and wherein the filtered material comprises milk protein concentrate.

17. The method of claim 12, wherein the filtration membrane exhibits a flux decline at room temperature of less than 5% after two hours of filtration.

18. The method of claim 12, wherein the filtration membrane is selected from the group consisting of a polymeric membrane, a cellulose membrane, a nanocellulose membrane, an ultrafiltration membrane, an ionic liquid membrane (ILM), or combinations thereof.

19. The method of claim 12, wherein the filtration membrane comprises a nanocellulose membrane.

20. The method of claim 12, wherein the filtration membrane comprises an ionic liquid membrane (ILM).

21. The method of claim 12, wherein the ionic liquids associated with the filtration membrane comprise imidazolium-based ionic liquids, wherein the imidazolium-based ionic liquids are selected from the group consisting of 1-Ethyl-3-methylimidazolium acetate, 1-Butyl-3-methylimidazolium acetate, 1-Ethyl-3-methylimidazolium chloride, 1-Butyl-3-methylimidazolium chloride, 1-Ethyl-3-methylimidazolium tetrafluoroborate, or combinations thereof.

22. The method of claim 12, wherein the imidazolium-based ionic liquids comprise 1-ethyl-3-methylimidazolium acetate.

23. The method of claim 22, wherein the zwitterionic molecules comprise a negatively charged group and a positively charged group, wherein the negatively charged group comprises a carboxylate group, and wherein the positively charged group comprises ammonium group.

24. The method of claim 12, wherein the zwitterionic molecules are selected from the group consisting of L-Serine, L-Glycine, L-Alanine, L-Glutamic acid, L-Aspartic acid, sulfobetaine, phosphorylcholine, carboxybetaine, or combinations thereof.

25. The method of claim 12, wherein the zwitterionic molecules comprise L-serine.

26. A method of modifying a filtration membrane, said method comprising:
associating a surface of the filtration membrane with zwitterionic molecules, wherein the associating results in the covalent coupling of the zwitterionic molecules with the surface of the filtration membrane, and wherein the filtration membrane comprises a plurality of ionic liquids associated with the filtration membrane.

27. The method of claim 26, wherein the filtration membrane comprises a nanocellulose membrane.

28. The method of claim 26, further comprising a step of associating the ionic liquids with the filtration membrane.

29. The method of claim 26, wherein the ionic liquids associated with the filtration membrane comprise imidazolium-based ionic liquids, wherein the imidazolium-based ionic liquids are selected from the group consisting of 1-Ethyl-3-methylimidazolium acetate, 1-Butyl-3-methylimidazolium acetate, 1-Ethyl-3-methylimidazolium chloride, 1-Butyl-3-methylimidazolium chloride, 1-Ethyl-3-methylimidazolium tetrafluoroborate, or combinations thereof.

30. The method of claim 26, wherein the zwitterionic molecules comprise a negatively charged group and a positively charged group, wherein the negatively charged group comprises a carboxylate group, and wherein the positively charged group comprises ammonium group.

31. The method of claim 26, wherein the zwitterionic molecules are selected from the group consisting of L-Serine, L-Glycine, L-Alanine, L-Glutamic acid, L-Aspartic acid, sulfobetaine, phosphorylcholine, carboxybetaine, or combinations thereof.

32. The method of claim 26, wherein the zwitterionic molecules comprise L-serine.
